(19) United States
(12) Patent Application Publication
(10) Pub. No.: US 2022/0091420 A1
(43) Pub. Date: Mar. 24, 2022

(54) AUGMENTED REALITY SYSTEM

(71) Applicant: DIRECTIONAL SYSTEMS TRACKING LIMITED, Southampton (GB)

(72) Inventors: David Woods, Abingdon, Oxfordshire (GB); David Grey, Abingdon, Oxfordshire (GB)

(21) Appl. No.: 17/420,020

(22) PCT Filed: Jan. 16, 2020
(86) PCT No.: PCT/GB2020/050091

§ 371 Date: Jun. 30, 2021

(30) Foreign Application Priority Data
Apr. 23, 2019 (GB) 1905643.1
Apr. 23, 2019 (GB) 1905644.9

(51) Int. Cl. G02B 27/01; G02B 7/04; G02B 6/34

(52) U.S. Cl. CPC G02B 27/0172; G02B 27/0176; G02B 2027/0134; G02B 6/34; G02B 7/04

(57) ABSTRACT

A device for attaching to an asset in order to allow the location of the asset to be tracked. The device comprises: a hermetically sealed outer casing; and a circuit board hermetically sealed within the outer casing. The circuit board comprises a low power wireless radio frequency transmitter and electronic components for causing the transmitter to repeatedly transmit a device identifier at intervals that are randomly varied around a fixed interval.

### TECHNICAL FIELD

This disclosure relates to a system and method that aims to reduce human error and add automation to the parking of a trailer in a docking bay, and to further automate management of the tractors and trailers in a distribution network. It also relates to a system and method for determining that an asset is loaded onto a given vehicle. It also relates to a system and method for detecting unauthorised access to a vehicle by a person. The present invention also relates to devices and a system that allow the tracking of individual tags that are attached to products (assets). Once attached, the asset can be tracked remotely on a mobile device or computer device by the manufacturer and/or customer. The attached tag also maintains authenticity of the product throughout the supply chain.

### BACKGROUND

Securing an asset with an asset tracker is important: when you are unaware of the exact location and status of your asset(s) it is much easier for them to become lost or stolen or delayed. The results can be time lost in locating them, lost productivity, and the wasted cost of replacing missing assets. Examples of assets include, but are not limited to, car parts, perfumes, electronic equipment, wines, cages, containers, pallets. Examples of fixed assets include but are not limited to, machinery, vehicles, trailers and containers. Asset management of transported inventory is very important. For example, a logistics truck may collect packages/assets from a central distribution centre and deliver the packages/assets to a hub (called line hall). Once in the hub/yard, the trailer must be put into the correct docking bay. Verifying the right trailer is in the correct docking bay is very important. Furthermore, packages are loaded into cages which can be asset tracked ensuring the correct cage is placed in the correct trailer. As another example, a logistics truck may collect assets from a central distribution centre and deliver the assets to a hub. From the hub, the assets are delivered to a smaller storage facility, then to a store for retail sale to the customer. Consider as an example that a driver gets to the London distribution centre at 6 am and is tired. The driver is supposed to park his trailer into docking bay 12, but he parks the trailer in docking bay 13 by mistake. His trailer is unhitched and the driver drives off.

The trailer is loaded with more packages and a second driver comes to docking bay 13 and hitches the trailer to his truck and drives the trailer away, for example to Scotland. After sometime the mistake is discovered. The driver must return, so that the mistake can be rectified. This may be very costly due to the delays caused and compensation paid to customers for the delay. Consider as an example car parts that are manufactured in France. The car parts are put into a container specifically for car bumpers called “bumper parts for classic car 123”. The container containing bumper parts for classic car 123 is sent to Germany from France, then to Italy. Then once in Italy, the parts are then put into a large storage facility. The car manufacturer, in general, wishes to know exactly where the bumper parts for classic car 123 are, but they may typically have to wait for this information to be added to a computer system to find out. The parts may also be in transit or at a border. Once the parts arrive at the storage facility, a worker at the facility is told to get the container for bumper parts for classic car 123: he knows they are in the storage facility, but must now search for them. If they have been put in the wrong section of the facility, it will be time consuming for him to find them. In another example, 1,000 cameras are manufactured and put onto a pallet, before being transported from one country to another. The pallet arrives at the airport and is loaded onto a trailer. The pallet is taken to the central distribution centre which delivers the packages to a hub. From the hub, the packages are delivered to a smaller storage facility, then to a store for retail sale. Somewhere along the supply change, assets may have gone missing but this problem is only noticed once the pallet arrives at the retail store and the cameras are counted. The current invention looks to solve these problems.

### SUMMARY

Various aspects of the invention are set out in the appended claims. According to one aspect of the present invention there is provided a device for attaching to an asset in order to allow the location of the asset to be tracked. The device comprises a hermetically sealed outer casing; and a circuit board hermetically sealed within the outer casing. The circuit board comprises a low power wireless radio frequency transmitter and electronic components for causing the transmitter to repeatedly transmit a device identifier at intervals that are randomly varied around a fixed interval. The fixed interval may be in the range of 5 to 30 seconds. The maximum variation of the intervals around the fixed interval may, for example, be of the order of 500 ms, 5 s or 10 s or the maximum variation may be a proportion of the fixed interval, such as 10%, 30%, 50% or 80% of the fixed interval.

### BRIEF DESCRIPTION OF THE DRAWINGS

FIG. 1 shows docking bays and tractors and trailers with satellite trackers fitted, and a distribution yard layout with RF transmitters and receivers;

FIG. 2 shows how the data is transmitted to and from the trackers and to the asset management centre;

FIG. 3 shows the trackers collecting GNSS data and sending data; and

FIG. 4 shows the calculation used to define when a tractor and trailer are in the correct docking bay.

FIG. 5 shows the path of the data. The MAC code and identifier data from the tag is sent to the transceiver. The transceiver location on a map is always known as the transceiver collects GNSS data and pings this data to the server. The server can also send data to the transceiver. The server collates the received data. The data is then sent to a computer or sent to a mobile device. Also, as the mobile device gets nearer to the tag, the tag can send data direct to the mobile device.

FIG. 6 shows how a mobile device finding a tag using augmented reality, by super imposing the tags position through the mobile device display. The mobile device communicates with the server, the server displays the tags relative to the transceiver that has picked up the tag.

FIG. 7 shows the tag monitoring eco system. Either the manufacturer or customer can view the tags location at any time in the total supply chain. The manufacturing facility, transportation vehicle, storage hub and retail shop all have RF transceivers. The tag is in RF contact with the transceiver and the transceiver is tracked via GNSS so it's position on a map and time are always known. The data from the transceiver is send via GSM to the server and the mobile device and computer and in communication with the server, allowing both the mobile device and computer to locate the tag at any time. The customer can also authenticate the product with tag attached sent from the manufacturer is trustworthy due to the unique MAC code matching the code on the mobile device screen.

FIG. 8 shows the triangulation of the tag position based the signal strength sent by the tag to the transceivers in a room. Where the lines cross is the approximate position of the tag.

### DETAILED DESCRIPTION

Autonomous Management of the Tractors and Trailers in a Distribution Network Asset trackers for locating the position of an articulated vehicle comprising a tractor or cab and a trailer are known, and generally make use of a Global Navigation Satellite System, GNSS, such as GPS. Existing solutions will give an approximate location of a truck and trailer, but they cannot, in general, give exact positioning, e.g. positioning which is accurate enough to determine whether or not the vehicle is within the correct loading bay of a loading yard.

The GNSS device chosen has a better than average positioning accuracy. Once an accurate position measurement has been achieved then dead reckoning (DR) can be used to maintain accuracy until another corrective GPS reading can be taken. Dead reckoning is the process of calculating a current position by using a previously determined position, or fix, and advancing that position based upon known or estimated speeds over elapsed time and course.

The approach proposed here makes use of a plurality of trackers fixed at various locations along the length of the vehicle and which allow a centre-line of the vehicle to be determined. By verifying that this centre-line is correctly aligned with respect to a known centre line of the bay, it is possible to greatly improve the confidence that can be placed in vehicle location determinations.

Consider for example two trackers fixed to a vehicle. It would be possible to determine locations for each tracker using GNSS, and to determine whether both trackers are located within a virtual zone for a given bay, and to thereby determine whether or not the vehicle is parked in the correct bay. However, both trackers will be subject to errors, possibly up to several meters. If we can verify that both trackers report locations that are on or close to the centre line of the bay, either by GPS, DR data or a combination of both, we can further increase the confidence that the vehicle is in the correct bay. In this way we are making use of the knowledge not only that both trackers should be reporting locations within the correct bay, but also that the trackers are reporting locations that are aligned with the centre line of the bay. With a single source of GPS data position can be established but heading (i.e. the orientation of the centre-line of the vehicle) cannot. The use of heuristics within the server program is used to determine the correct heading given a known direction.

A magnetometer may also be incorporated in the tracker to give the correct heading of the GNSS unit.

It is further noted that the positions of the trackers on the vehicle is critical. If the spacing between the trackers along the vehicle is relatively large, we can obtain a better determination of the heading of the vehicle. We can then better determine the alignment of that vehicle centre-line with the centre-line of the loading bay.

It is recognised that, for purposes of weather protection, the end of a loading bay closest to the building may be covered, such that any GNSS tracker located at the rear of the trailer may report an inaccurate position. In order to maximise the spacing between trackers it is preferable to locate one tracker on the trailer at a position that will not be under a loading bay cover, whilst locating a second tracker on the truck. When a vehicle is correctly parked in a bay, it is safe to assume that the truck and the trailer will be aligned, and that a centre-line running between the trackers should still be aligned with the centre-line of the bay.

In the example given, the truck moves the trailer in to position, but in other examples, a tractor may be used to move the trailer. The tractor may have a GNSS tracking unit attached to it.

The asset tracker can report its geographical position, movement data, time of movement, whether the asset tracker has moved out of a predefined location on a map, for example, the asset tracker may be attached to a machine that is in a particular location geographically and movement outside of the location could mean the asset is being stolen.

If the asset tracker moves, an electronic movement detector, such as an accelerometer, may be activated and switch on a global positioning system GNSS circuit. The GNSS circuit will check the assets current position against predefined coordinates and rules to check it's within the parameters of the predefined coordinates.

If the tracker is located outside of these predefined coordinates, a message can be sent to the monitoring facility.

The said system comprises a robust composite mechanical housing attached to the asset. Inside the housing is a solar charged battery which powers an electronic satellite tracking circuit board with antennas, the electronic tracking circuit board can transmit the location of the asset that it's attached to, sending that data to a monitoring facility. The said system includes an identifier code attachable to said asset tracker.

An owner or guardian of said asset registers said asset tracker with the identifier code with an enabling facility; in one embodiment, the identifier code is either entered into a computer before the asset tracker is attached to the asset or in a further embodiment the identifier code is transmitted via short message service (SMS) to said enabling facility by owner or guardian or, in another embodiment, the identifier code is entered into a computer and sent to the enabling facility, or the identifier code is given to the enabling facility verbally.

In another embodiment, the tracker identifier code forms part of a Quick Release (QR) code, and the code is scanned with a scanner and the identity of the tracker is transmitted to a server.

In a further embodiment, the tracker QR code is scanned and the vehicle registration plate is also scanned and this information is transmitted to a server where said tracker and vehicle and or vehicle trailer are linked together.

The asset tracker may have circuit board(s) inside a housing being capable of being tracked remotely via mobile or computer.

The tracker has a Solar cell, rechargeable battery, Radio Frequency (RF) transceiver, In one example Bluetooth is used, but those skilled in the art can use other methods to send and receive data. It also has a satellite tracking module, and cellular mobile network RF module, for 2G, 3G, 4G, Quad bands frequency (850/900/1800/1900 MHz), making it compatible with all the major GSM networks in the world. The 850/1900 MHz bands are mainly used in the US, while the 900/1800 MHz ones are available in most other countries worldwide

The data transmitted and received is Global Navigation Satellite System data and is the standard generic term for satellite navigation systems that provide autonomous geo-spatial positioning with global coverage. This term includes e.g. the Global Positioning System (GPS), Global Navigation Satellite System (GLONASS), Galileo, Beidou and other regional systems.

A tracker owner can set up a yard where vehicles with trackers attached drive to. The yard can be fitted with RF transmitters and receivers in the yard (Beacons), spaced in a manner to give full RF coverage in the yard, so when a vehicle entering the yard has a tracker fitted with its RF on, the asset management system will know and it can communicate with the trackers.

The beacons can be solar charged or in a further embodiment can be wired up to a permanent power supply.

The current system looks to solve the problem of asset management for distribution and verify that the right trailer is in the correct docking bay, reducing the scope for human error.

Here, the vehicle is called a tractor and the proposed system involves a number of trackers attached to the tractor and the trailer that the tractor pulls.

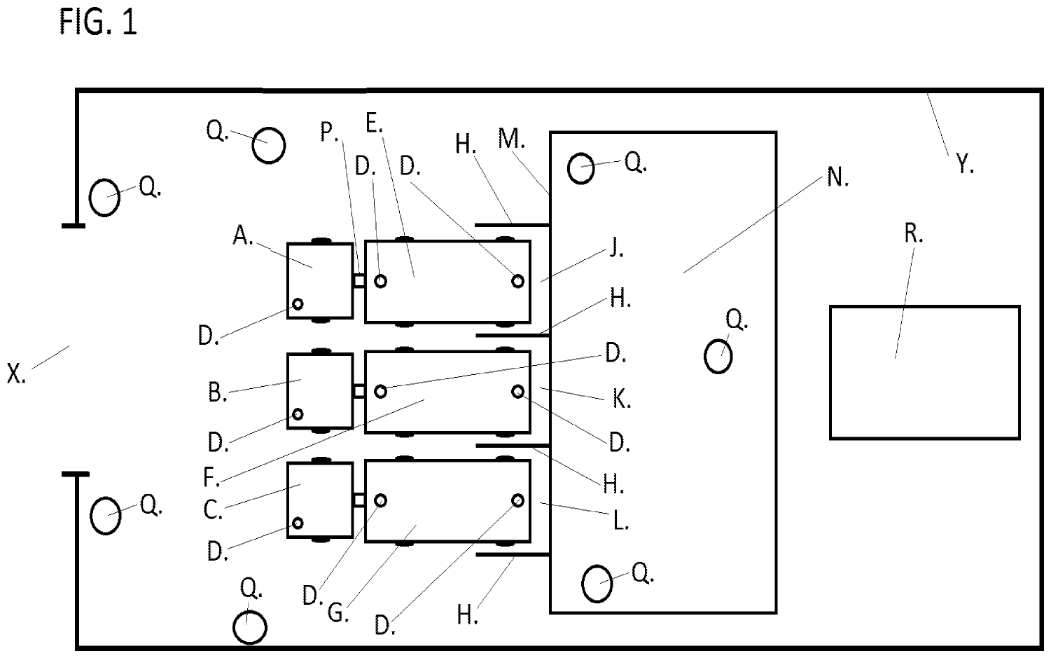

A typical trailer might be 40 feet long and 8 feet wide. The tracker unit is attached to the tractor and then a tracker is attached one end of the trailer and another tracker is attached to the opposite end of the trailer, preferably attached in the centreline of the trailer. In FIG. 1, reference E shows the trailer D shows the position of the trackers attached to the tractor and trailer. The trackers can be attached to the trailer using magnets or using mechanical fixing means. The tracker can be attached to the tractor windscreen using adhesive or can be mechanically attached to the tractor.

The trackers for the trailer switch on GNSS when they enter the entrance of the distribution yard and switch off GNSS when they leave the yard, to conserve battery power. They do this by detecting they are in an RF zone. The distribution yard has an RF zone created by a number of RF transmitter and receiver's beacons placed throughout the yard. These beacons create an overlapping RF zone throughout the yard. The RF zone can monitor what vehicle is entering and leaving the yard and allows data to be sent and received by the trackers, including GNSS received data.

The GNSS data can be transmitted for example every one second that the vehicle is in the yard. The data is sent to an Asset management control centre via the RF zone, where the controller or autonomous software can use a Graphical User Interface (GUI) representation of tracked vehicles, docks and buildings in the yard on computer screen for managing the assets entering and leaving the yard.

The vehicle entering the yard will automatically be assigned a trailer parking space or a docking bay allocated for the vehicle trailers. The driver of the vehicle with trailer will be told which parking space/docking bay to park the trailer in. The assigned parking space/docking bay will have a virtual zone created and which is dictated by the width and length of the docking bay. This width and length is set for all docking bays and designed for a tractor and trailer to fit within the virtual zone.

The tractor has a tracker unit attached that sends continuous GNSS data when in the yard. The Trailer has one or more tracker units that send continuous GNSS data when in the yard. As the driver parks the tractor and trailer into the docking bay, the Asset management control centre can automatically check the received GNSS data from the trackers, to check the GNSS data criteria is within the virtual docking bay zone. If it is not, the driver can be informed immediately to park correctly.

In a further embodiment, the asset management control centre can send real time data to the tracker unit in the tractor: the tracker unit can have a display to indicate to the driver if he is parking in the correct docking bay. The display could be visual and show a picture or video of the various docking bays and highlight in real-time the docking bay that the driver is being requested to park in, giving real-time indication if he parks in the right or wrong docking bay.

In a second embodiment, the indicator to the driver is via lights. In one example, a red light indicates that the vehicle is in the wrong docking bay and a green light indicates that it is in the correct bay.

In a further embodiment, audio can be used to indicate to the driver if he is in the correct docking bay.

If a driver is instructed to hitch a trailer in docking bay 12 to his tractor, but he hitches the tractor to the wrong trailer and attempts to drives off, this will be automatically captured by the asset management control centre and the driver can be instructed to rectify the mistake.

In a further embodiment, the asset tracker circuit is a GNSS, charged by a solar cell and plurality of batteries, and the circuit will have a cellular mobile network RF module to transmit the coordinate data from the tracker position to the asset management control centre when outside the distribution yard.

In another embodiment, the tractor with the asset tracker circuit is a GNSS, powered by the vehicle electrical system. The circuit will have a cellular mobile network RF module to transmit the coordinate data from the tracker position to the asset management control centre when outside the distribution yard. This will allow the asset management control centre to communicate with the vehicle driver and also receive GNSS data, to plan if the vehicle has broken down, or is in traffic or delayed.

The asset management control centre can also check via the cellular mobile network that the tractor has the right trailer, as both the tractor and trailer can communicate together via RF.

In another embodiment, the asset tracker circuit has a Bluetooth (BT) radio system with a battery power supply charged by a solar cell, such that the BT transmits or receives signal or signals from the tracker position to a receiver or from a transmitter.

In a further embodiment, the asset tracker circuit has a Low Power Wide Area Network (LoRA) Radio System with a battery power supply, charged by a solar cell. The LoRA system transmits signal or signals from the tracker position to a receiver.

It may be advantageous to use solar cell battery charging for asset tracking due to the power requirement of transmitting asset data via radio transmission as the asset tracker is not typically connected to an external power supply and thus relies solely on battery power.

It is advantageous to place the asset tracker in clear view of the sky so light can fall onto the solar cell to allow battery charging.

It also advantageous to place the asset tracker in clear view of the sky for GNSS and for transmission of radio waves, making it more efficient to lock on to satellite positions required for obtaining satellite positioning and more efficient to transmit data via radio waves to cell antennas.

In the following detailed description it will be helpful to refer to the following references used in the drawings:

FIG. 1: A. Tractor 1; B. Tractor 2; C. Tractor 3; D. Satellite tracker; E. Trailer 1; F. Trailer 2; G. Trailer 3; H. Docking bay barrier; J. Docking bay 12; K. Docking bay 13; L. Docking 14; M. Docking bay building wall; N. Docking bay building; P. Hitching; Q. RF transmitter and receiver beacon; R. Asset management control centre; X. Entrance and exit for vehicles; Y. Distribution Yard.

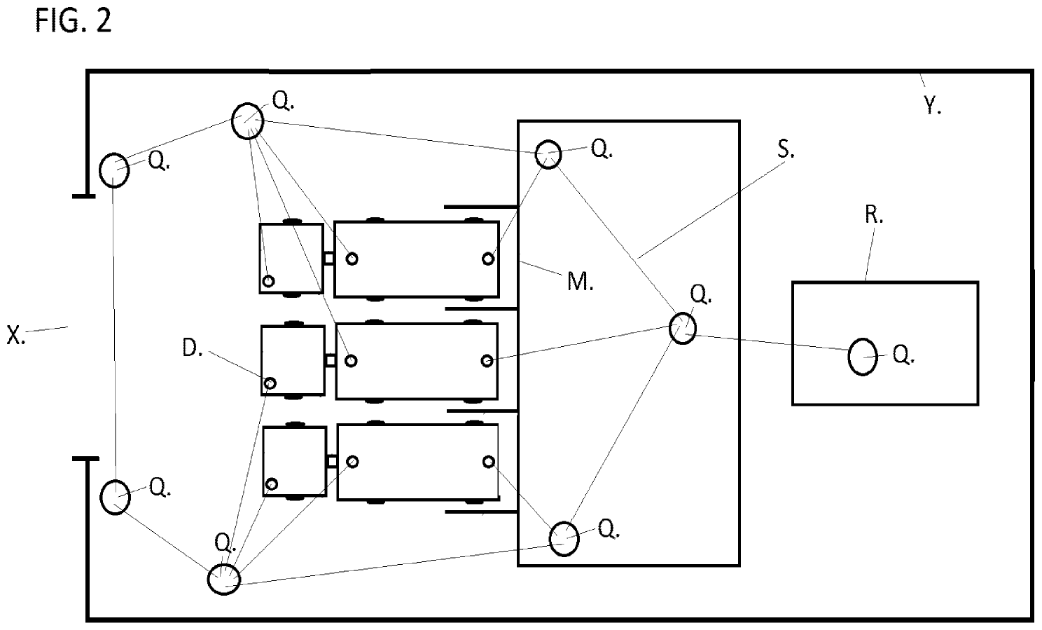

FIG. 2: D. Satellite tracker; M. Docking bay building wall Q. RF transmitter and receiver beacon; R. Asset management control centre; S. RF data sent and received path; X. Entrance and exit; Y. Distribution Yard

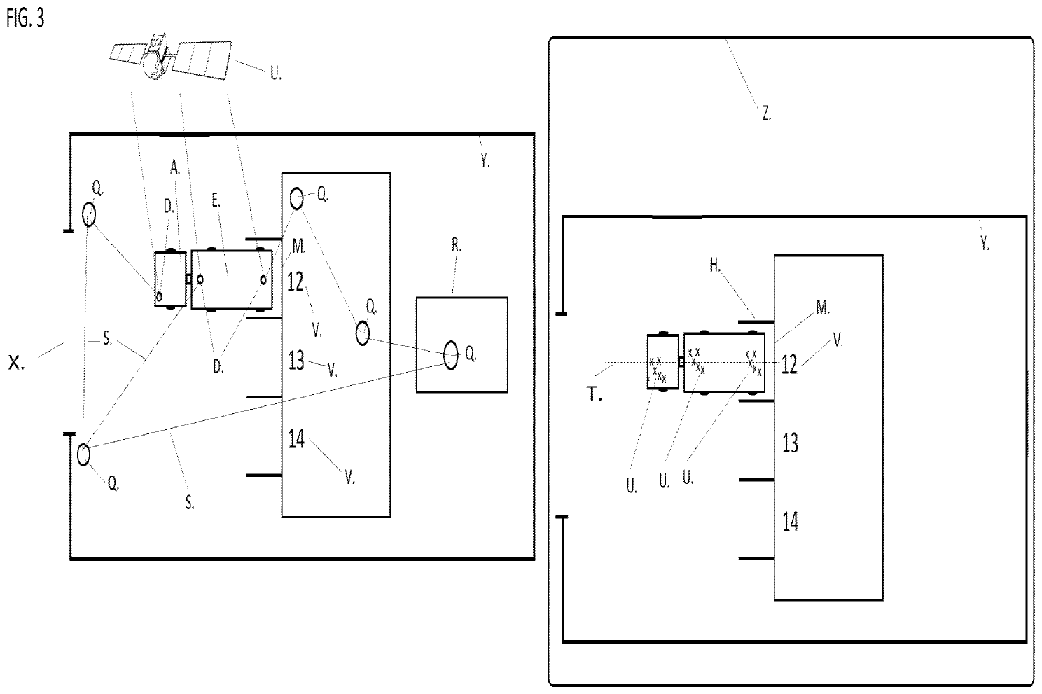

FIG. 3: A. Tractor 1; D. Satellite tracker; E. Trailer 1; H. Docking bay barrier; M. Docking bay building wall; Q. RF transmitter and receiver beacon; R. Asset management control centre; S. RF data sent and received path; T. Docking bay centre line; U. Received GNSS data; V. Docking bay; X. Entrance and exit for vehicles; Y. Distribution Yard; Z. GUI representation of tracked vehicles, docks and yard on computer screen for managing assets.

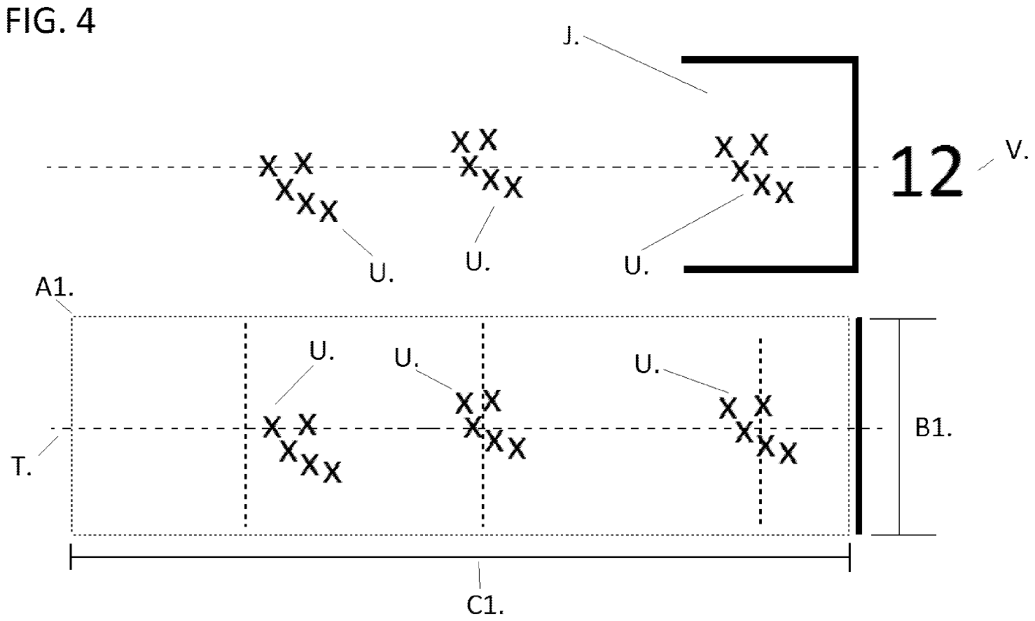

FIG. 4: A1. Docking bay virtual zone; Bl. Width of docking bay; C1. Length of docking bay zone; J. Docking bay 12; T. Docking bay centre line; U. Received GNSS data; V. Docking bay

A calculation used to check the assigned trailer is in the correct assigned docking bay, makes use of a virtual zone created on computer. This virtual zone shape and size represents the bay or the trailer parking bay. A tracking unit will, most likely, be attached to the front of the trailer. The computer program on the server will know where the tracking unit really is on the trailer and will, therefore, be able to produce a virtual point dead centre on the front of the trailer. By using the GNSS data it will be possible to deduce the heading of the trailer thereby producing a further virtual point at the rear of the trailer. In FIG. 2 these are represented by Points D on the trailers.

It is important that the accuracy of the GNSS positioning data be within 1 metre. Reference T in FIG. 4 represents this. In this figure U is used to represent the GNSS position points from the tractor (one) and from the trailer (two). The X represents variation of the actual position sent. As long as this is within the virtual zone of the bay or parking area then the trailer is parked correctly. Generally, the bays are physically guarded by rails or other physical barriers. With the trailer parking space these barriers may not exist and, therefore, it would be possible for the driver to park the trailer across 3 or more bays. Creating the virtual point at both the front and rear of the trailer will allow the calculation of the orientation of the trailer and correctly handle that situation.

The Distribution Yard will have buildings that may cause the GNSS positioning data to be distorted. When entering the Yard, the tractor trailer unit will need to stop for at least 10 seconds within an area free from building overhangs. This is most likely to be the entrance barrier. Again, this will be calculated by using zones. Once this stabilisation has completed the GNSS device will switch to Dead Reckoning so that GNSS location data is no longer distorted. Other zones will exist within the yard that are error free e.g. most of the trailer parking area so any time the trailer is within one of these areas it will reset the Dead Reckoning.

When the tractor and trailer are being parked, continuous GNSS data from the trackers is being transmitted. Only GNSS data that is in the virtual zone is taken into consideration for parking. There could be many GNSS data pings coming in, thus it's important to use an algorithm to triangulate the pings from three trackers to get them to fall on the virtual centre line of the docking bay FIG. 4 T. This should be achieved when the vehicle is perpendicular to the docking bay. Once complete, an instruction can then be sent to the driver to state they've parked in the correct bay.

Another embodiment of Tracking Device can be used within the Yard or within the building containing the Bays. Using triangulation, it would be possible to approximately locate Bluetooth devices such as the type to track the cages. It can also be used to asset track the trackers fitted to the trailers themselves.

The best results, however, will be obtained if the trailer is, in effect, a Faraday Cage. This means that the Tracking Device mounted on the front of the trailer will be able to use its Asset Tracking Function to detect Bluetooth Assets (or other LoRA device) within the cage and transmit their existence to the server. In this way we can guarantee that the trailer contains all the cages that the computer system expects to be there.

In the case that the trailer does not contain a Faraday Cage then the Asset Tracking Device attached to the trailer may see assets belonging to another, neighbouring trailer. Once there is enough distance between the trailers some of the assets within one trailer will appear to have been unloaded whilst the vehicle is moving but another trailer will, of course, still be tracking that asset. This is because the asset was being recorded as present on multiple trailers. Once this distance is achieved then it will be possible for the computer program to accurately determine that the trailer is carrying the correct assets.

An asset tracker may comprise a solar cell that charges a plurality of batteries that powers an asset tracker. The asset tracker housing has a foam insert that sandwiches the battery and circuit boards inside together, to hold them in place and position and protect from shock and vibrations. The foam is sealed together with the battery and circuit boards inside, to protect them further from ingress of water and/or dust.

In a further embodiment, a solar cell may not be used to charge the batter for the asset tracker and the tracker or trackers are connected to the vehicle or trailer electrical system.

In a further embodiment the tracking device can be interfaced into the trailer's telematics system. If the trailer weight is available via this interface then the tracking device can detect unexpected weight changes due to security breaches such as theft or stowaways.

In another embodiment, a passive infra-red (PIR) detector is connected to the tracking device inside the trailer to detect body heat. In the event of stowaways gaining access to the trailer, the device raises an alert to a server the tracking device is connected to. Other forms of unauthorised access to the vehicle by a person may also be detected using the PIR detector, e.g. unauthorised access to the vehicle by a thief.

Asset Tracking Tag

A tag comprising a case to house a radio frequency (RF) circuit board and powered by a battery are sealed closed.

The circuit comprises a plurality of batteries, an RF transceiver, a processor and antenna.

In a further embodiment, the tag circuit can contain sensors for measuring, time, light, temperature, movement, humidity, Ultra Violet radiation, a Piezo transducer.

In one embodiment, the electronic circuit would be protected from conditions that will affect its performance; examples of such conditions are temperature, water, agitation, force and shock. By placing the circuit in a case that seats the circuit, then immersing the circuit and battery in a gel polymer with a very slow isothermal peak that does not thermally stress the components on the circuit board, this then totally immerses the circuit and battery in the polymer gel and protects it from ingress of foreign bodies, such as dirt or dust, and from mechanical shock.

The protective polymer dielectric potting gel compound is a low viscosity sealing material to protect the circuit board and components. The gel is poured into the case immersing the circuit that is housing the circuit board, the case material is made from a material that can withstand high temperature, in one example of the case material Polytetrafluoroethylene, a synthetic fluoropolymer, is used, but other materials can be used. An example polymer gel is UL 94-HB from a company called Ray Tech.

In a further embodiment of the current invention, the circuit board is protected in the case by foam, between the circuit board and the tag case.

In another embodiment, the electronic circuit would be protected from conditions that will affect its performance; examples are temperature, water, agitation, force and shock. By placing the circuit in a case that seats the circuit made from rubber, then immersing the circuit and battery in rubber material does not set, or thermally stress the components on the circuit board, this then totally immerses the circuit and battery in the rubber and protects it and allows an amount of movement of the tag, so it can be attached to curved surfaces, in one example via an adhesive. It is proposed, that the tag is attached to the asset via adhesive, or tag is attached using rivets or screws via holes and slots in the tag case. When the circuit board is manufactured, its processor has a unique MAC code. MAC is an acronym for Message Authentication Code, which is an individual 17- or 18-digit alphanumeric number and is unique to all processors that are manufactured.

In another embodiment, the tracker identifier (MAC) code, forms part of a Quick Response (QR) code, and the code is scanned with a scanner and the identity of the tracker is transmitted to a server. The tag processor's MAC code is generated at the manufacturing stage and made into a QR and/or barcode label and the MAC code serial number is printed. This label is attached to the tag case. This helps identify one tag from another. When the tag is attached to the asset or product, the QR code is scanned by a scanner, which can be a mobile device camera or hand-held scanner, for example. Alternatively the serial number can be entered into a device, and this data is then entered into a computer system, along with a description name of what the tag is attached to.

In one example the tag is attached to a perfume box. The tag is scanned, a description name is entered, which is then sent to the cloud server. The Mac code/serial number is unique, i.e. there can never be two identical Mac codes. It may be helpful to refer to the following references used in the drawings:

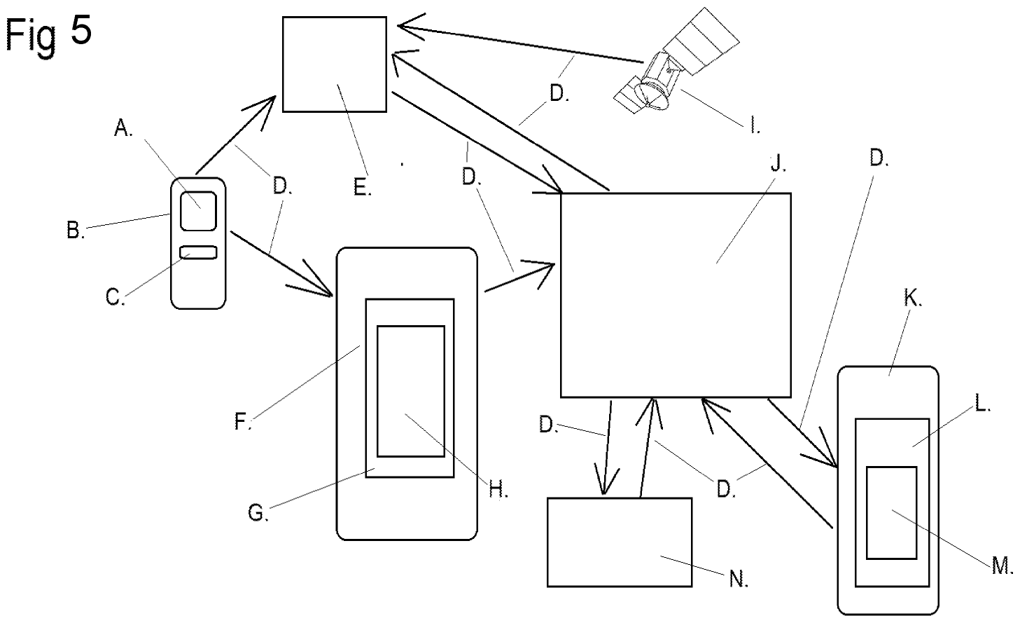

FIG. 5: A. Barcode/Quick Release (QR) code; B. Tag; C. Serial number; D. Data flow direction; E. Transceiver; F. Mobile device; G. Display; H. Data entry describing the tag; I. Satellite; J. Cloud server for collecting data; K. Mobile device; L. Display; M. Information about the tag; N. Computer terminal.

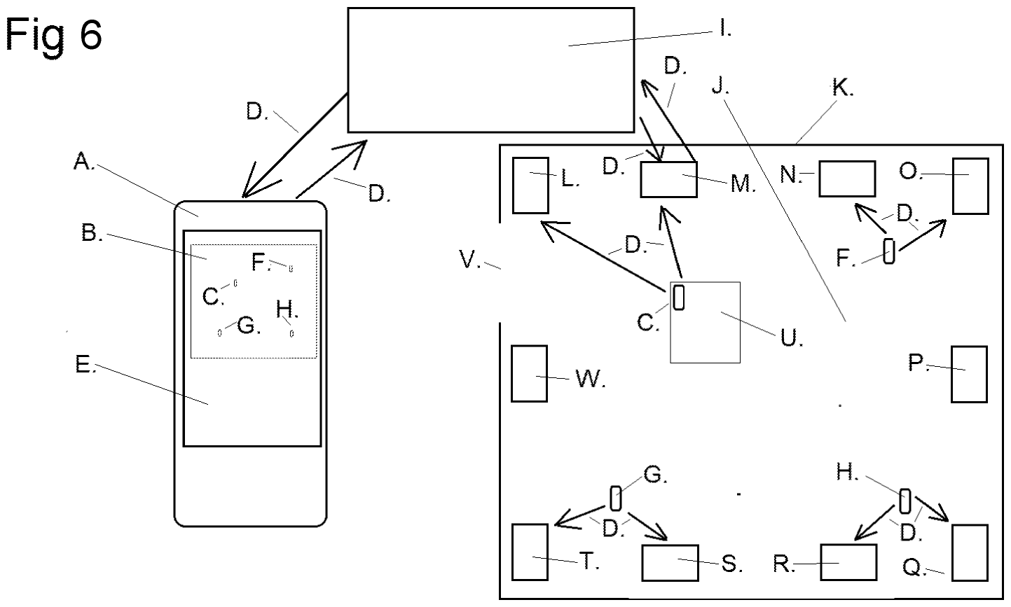

FIG. 6: A. Mobile device; B. Display; C. Tag 1; D. Data flow direction; E. Display; F. Tag 2; G. Tag 3; H. Tag 4; I. Cloud Server for collecting data; J. Storage area; K. Storage building; L. Transceiver 1; M. Transceiver 2; N. Transceiver 3; O. Transceiver 4; P. Transceiver 5; Q. Transceiver 6; R. Transceiver 7; S. Transceiver 8; T. Transceiver 9; U. Pallet; V. Entrance to storage building; W. Transceiver 10.

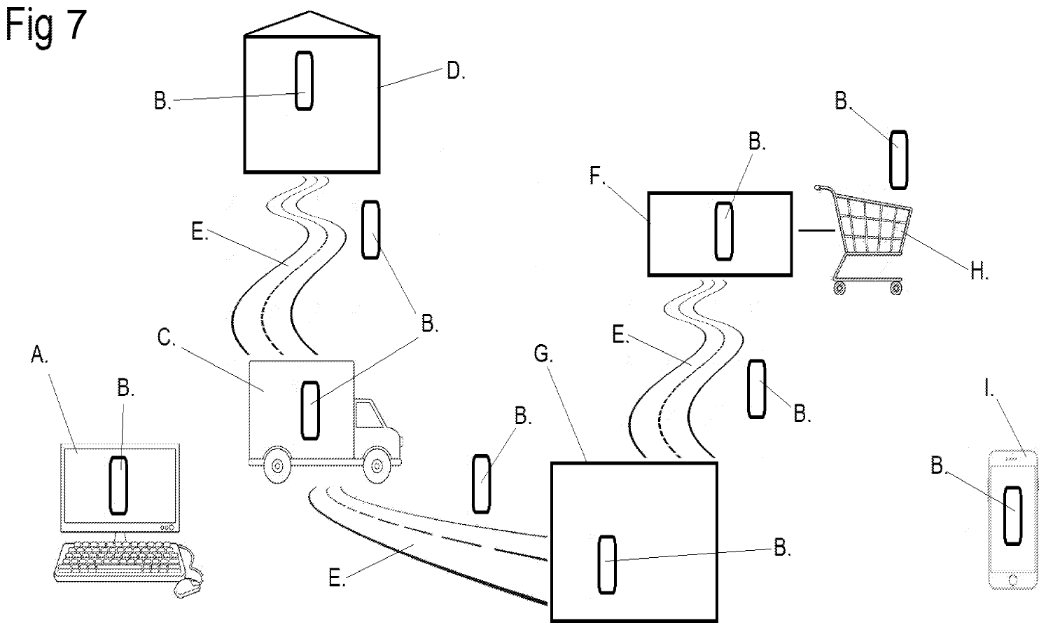

FIG. 7: A. Manufacturers computer; B.Tag; C. Van with transceiver fitted; D. Manufacturing facility with transceiver fitted; E. Road; F. Retails store with transceiver fitted; G. Storage hub with transceiver fitted; H. Customer; I. Customer mobile device.

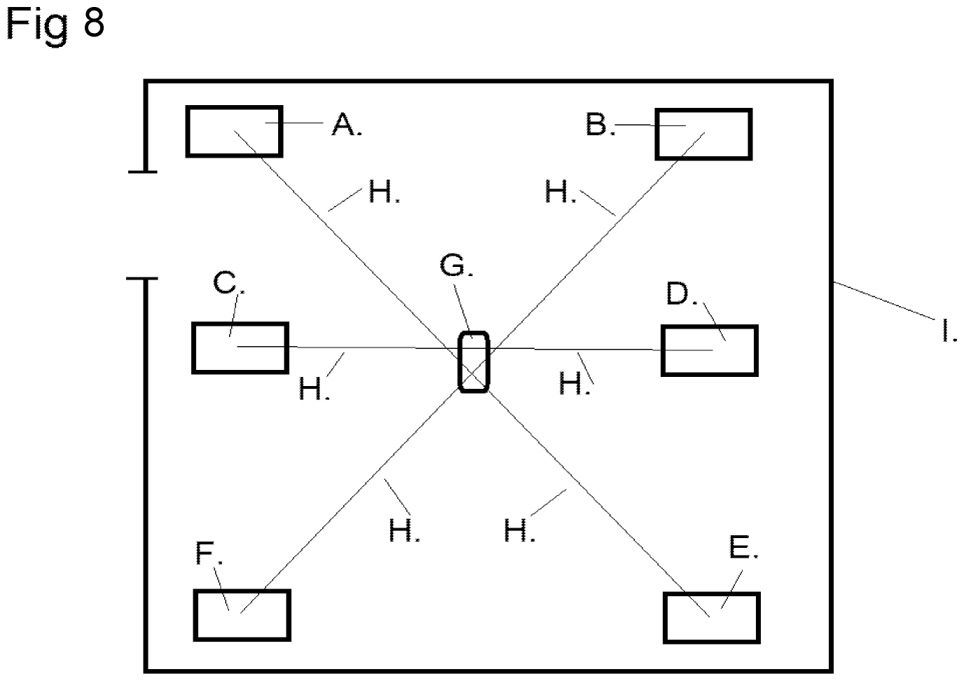

FIG. 8: A. Transceiver 1; B. Transceiver 2; C. Transceiver 3; D. Transceiver 4; E. Transceiver 5; F. Transceiver 5; G. Tag; H. Data direction; I. Storage room.

FIG. 5. A shows the QR code on the tag. FIG. 1. F shows the mobile device. FIG. 5 H shows the data entry on the mobile device where the description of the tag is entered. Once entered, this description and serial number are then sent to the cloud server, FIG. 5. J. Each tag's firmware transmission timing is different from the other, to avoid collision of signals from different tags when these signals are received by the transceiver. For example, the tag circuit board are designed to send a plurality of RF signals at different intervals, which helps to reduce collision issues when many tags are in close proximity to each other and sending data to the same transceiver on the same frequency.

These plurality of RF signals are received by a plurality of transceivers. As shown in FIG. 6. The transceiver is an electronic unit that connects to a telephone network via a cellular network (e.g. 3G or 4G). The transceiver also has a GNSS unit, (Global Navigation Satellite System), is the standard generic term for satellite navigation systems that provide autonomous geo-spatial positioning with global coverage. Using GNSS, the transceiver's location can always be determined on a map. The tag sends a Radio Frequency (RF) identifier that is the processor's MAC code. The tag sends this RF identifier every 0.5 milliseconds, on three different frequencies near to 2.4 GHz.

The tag sends its data to a transceiver; the transceiver has a plurality of independent RF transceivers, each for receiving one of the transmitted frequencies from the tag. This further reduces the possibility of collision when multiple tags are transmitting near to each other. The tag sends its ID data to a transceiver, which in turn stores the ID data and sends this data to a cloud server. The data sent comprises, for example, the ID of the tag and the time stamp and GNSS data and battery level data of the tag. The cloud server then can show the location of the proximity of the tag on a map.

At the server level, the ID for the tag is a serial number. The serial number is converted to a description name of the asset it is attached to. The description name is assigned to the tag when the tag is attached to the asset. Thus, if a person is looking for a particular asset, they can enter a name for the asset as opposed to entering the serial number for the tag.

In an example, the tag C (FIG. 6) is attached to a pallet (FIG. 6.U) that has mobile phones inventory on it. The tag C is for example named “Acme Mobile phones”. A worker is asked to find the pallet with “Acme Mobile phones”. The worker would use a dedicated mobile App that is linked to the server, the worker enters “Acme Mobile phones” into his mobile device that connects to the server (FIG. 6. I) and enters the storage facility. In FIG. 6. the tag C, RF is picked up by transceivers L and M. As both transceivers have GNSS, their position on a map is known. This information is then sent to the server FIG. 2. I and this information sent from the server to the mobile device FIG. 6. A. The worker with the mobile device FIG. 6. A. goes into the storage area in FIG. 6. J, they would see the approximate location of the “Acme Mobile phones” relative to the transceivers L and M, this then helps the worker to locate the pallet.

In a further embodiment, the mobile device has its own RF transceiver, and the tag named “Acme Mobile phones” can be received by the mobile device directly, this will further help to locate the Tag named “Acme Mobile phones” using the signal strength of the RF tag to the mobile device antenna via the display on the mobile device. As the mobile device is moved around, the mobile device antenna can find the strongest signal, and follow a visual indicator on the mobile screen until they locate the tag (Acme Mobile phones).

In one example, one or more transceivers may be fitted at a manufacturing facility. Also, the transceivers are attached to the trucks and trailers that carry the tagged manufactured goods. The central distribution centre also has transceivers in its storage building. The transceivers are also fitted to the van that carry the assets from the storage facility to the smaller storage facility, then to a store for retail sale to the customer.

If a tag is attached to the product at the factory, the transceiver near the tag collects the tag data, and If the product is then taken to another location, this allows the manufacturer to find the tag anywhere in the supply chain (FIG. 7) when connected to the server via a computer or mobile device.

Key aspects of an asset tracker are management and financial reporting. The entire life cycle of an asset is considered from the time of acquisition and commissioning, through maintenance and deployment, to decommissioning and replacement. Location and status must be updated as needed and management reports on status, condition, and location must be available.

The asset tracker can report its geographical position, movement data, time of movement, whether the asset tracker has moved out of a predefined location on a map, for example, the asset tracker may be attached to a machine that is in a particular location geographically and movement outside of the location could mean the asset is being stolen.

In one embodiment, the tag is fitted with an electronic movement detector, such as an accelerometer or other type of inertial sensor, in order to obtain acceleration or “G force” data. If the G force were to go to a predefined level, this information is sent to the transceiver and logged. This could then raise an alert to the owner.

In a further embodiment of the same invention, the tag is fitted with a temperature detector, such as a thermistor. If the temperature were to exceed a predefined level, this information is sent to the transceiver and logged. An alert to the manufacturer could then be raised.

In a further embodiment of the invention, the tag is fitted with a light detector, such as a light sensor. If the light were to go to or above a predefined level, this information is sent to the transceiver and logged. An alert to the manufacturer could then be raised.

In another embodiment of the invention, the tag is fitted with an audio sounder, such as a Piezo Transducer. In the event the tag needs to be located, a signal can be sent from the mobile device or the transceiver to the tag circuit via RF, the tag then activates the audio sounder. This aids a person locating a tag. The sounder may, for example, be activated by the mobile device when the mobile device is within a predetermined range of the tag.

In an embodiment of the invention, the RF tag's position is more accurately located using a transceiver that has a plurality of helix antennas and ground plane integrated into the transceiver.

In an embodiment of the current invention, the RF tag's position is more accurately located using a unit that has a plurality of helix antenna's and ground plane integrated, that are attached to the transceiver via a connecting port.

In an embodiment of the current invention, the tag will send a signal using a plurality of different RF frequencies and/or different powers, to allow transceivers operating at different frequencies to obtain the RF signal. In one example, a mobile device receives one of the frequencies and a separate transceiver receives another frequency. This allows different transceivers to work with the same tag, e.g. transceivers which are located at different distances from the tag.

1. A device for attaching to an asset in order to allow the location of the asset to be tracked, the device comprising:
a hermetically sealed outer casing; and
a circuit board hermetically sealed within the outer casing and comprising a low power wireless radio frequency transmitter and electronic components for causing the transmitter to repeatedly transmit a device identifier at intervals that are randomly varied around a fixed interval.

2. A device according to claim 1, wherein said fixed interval is in the range of 5 to 30 seconds.

3. A device according to claim 1 or 2, wherein said electronic components cause the transmitter to transmit said device identifier using one of a plurality of different frequencies.

4. A device according to claim 3, wherein said plurality of different frequencies are frequencies with an allocated frequency band.

5. A device according to claim 4, wherein said circuit board is configured to use the Bluetooth™ protocol and said allocated frequency band is the allocated Bluetooth™ band, e.g. 2.400 to 2.485 GHz.

6. A device according to any one of the preceding claims, wherein said radio frequency transmitter and said electronic components are integrated as a single integrated circuit component.

7. A device according to any one of the preceding claims and comprising means for fixing the device to an asset or to asset packaging.

8. A system for tracking the location of assets and comprising:
a multiplicity of devices according to any one of claims 1 to 7; and
a plurality of base stations each comprising a set of wireless radio frequency receivers configured to receive data transmitted on respective ones of said different frequencies.

9. A system according to claim 8 and comprising a server or servers for receiving device identifiers received by base stations from devices, and for determining an approximate location of the devices using triangulation or another location resolving method.

10. A system according to claim 9 and comprising a plurality of user computer devices such as tablet computers or mobile phones, said server or servers being configured to send approximate location information for a device of interest to one of said computer devices requesting that information, the computer device being configured to present the information on a display as an overlay on a map or captured video image.

11. A system according to claim 10, wherein said computer devices each comprise an antenna or antennae configured to receive a device identifier from a device and electronic components for determining local location information for the device from received signals.

12. A system according to claim 11, wherein said computer devices are configured to switch said presentation from a location provided by said server or servers to said local location information when the latter is determined to be more accurate.

13. A system according to any one of claims 8 to 12, wherein said plurality of base stations includes a plurality of base stations at fixed locations around a given service area, such as a warehouse.

14. A device for attaching to an asset in order to allow the location of the asset to be tracked, the device comprising:
a hermetically sealed outer casing;
a circuit board comprising a low power wireless radio frequency transmitter and electronic components for causing the transmitter to repeatedly transmit a device identifier; and
a polymer gel within the casing and within which the circuit board is embedded, wherein the properties of the gel and the casing are such that they do not significantly impede signals transmitted by the radio frequency transmitter.

15. A device according to claim 14, where the circuit board is mounted to the casing via a plurality of pegs formed integrally with the casing.

16. A computer-implemented method of determining that vehicles are parked correctly within assigned elongate loading bays of a loading yard, the method comprising:
identifying and recording geographic coordinates defining respective longitudinally extending centre-lines of the loading bays;
for a vehicle within the loading yard, obtaining geographic coordinates reported by two or more GNSS trackers fixed to the vehicle at spaced apart locations along the length of the vehicle;
determining a centre-line of the vehicle using the geographic coordinates reported by said two or more GNSS trackers; and
determining an alignment of the determined centre-line of the vehicle with a centre-line of an allocated one of said loading bays.

17. A method according to claim 16, wherein said vehicle is an articulated vehicle comprising a tractor and a trailer and at least one of said GNSS trackers is fixed to said tractor and at least on of said trackers is fixed to the trailer.

18. A method according to claim 17, wherein said GNSS trackers are fixed to the vehicle in a region that lies in front of a midpoint of the vehicle.

19. A method according to any one of claims 16 to 18, wherein said step of determining a centre-line of the vehicle using the geographic coordinates reported by said two or more GNSS trackers also makes use of dead-reckoning.

20. A method according to any one of claims 16 to 19, wherein said step of determining a centre-line of the vehicle using the geographic coordinates reported by said two or more GNSS trackers comprises correcting reported data using absolute positional information reported by GNSS trackers having fixed locations within said loading yard.

21. A method according to any one of claims 16 to 20 and comprising detecting, at one or more of said GNSS trackers, radio signals broadcast by one or more radio transmitters located within said loading yard and using the detection or loss of a signal to switch on and off GNSS functionality of the trackers as the vehicle enters and leaves the yard.

22. A system for determining that vehicles are parked correctly within assigned elongate loading bays of a loading yard, the system comprising:
a server or servers for recording geographic coordinates defining respective longitudinally extending centre-lines of the loading bays;
sets of two or more GNSS trackers, each set for fixing to a vehicle to be tracked at spaced apart locations along the length of the vehicle;
a receiver coupled to said server(s) for obtaining geographic coordinates reported by vehicles within the loading yard,
the server(s) being configured to determine a centre-line of a vehicle using the geographic coordinates reported by a set GNSS trackers fixed to the vehicle, and to determine an alignment of the determined centre-line of the vehicle with a centre-line of an allocated one of said loading bays.

23. A computer-implemented method of determining that an asset is loaded onto a given vehicle, the method comprising, at a server or set of servers,
receiving via a data communication network a notification from a GNSS tracker located on the given vehicle that the vehicle is in motion,
receiving from the vehicle a notification that an asset tracker located on said asset is loaded onto the given vehicle, and
using the received information to determine that the asset is loaded onto the given vehicle and not another vehicle.

24. A system for detecting unauthorised access to a vehicle by a person, such as a thief or stowaway, the system comprising:
a GNSS tracker for fixing to the vehicle, the GNSS tracker comprising a passive infra-red, PIR, detector for detecting infra-red radiation emitted from within or around the vehicle, analysing the detected infra-red radiation to determine whether a person is present in or around the vehicle, and for sending, to a server, a message comprising data indicative of a person having been detected; and
a server configured to receive the message from the GNSS tracker.

25. A computer-implemented method of detecting unauthorised access to a vehicle by a person, such as a thief or stowaway, the method comprising:
fixing to the vehicle, a GNSS tracker comprising a passive infra-red, PIR, detector;
using the PIR detector to detect infra-red radiation emitted from within or around the vehicle;
analysing the detected infra-red radiation to determine whether a person is present in or around the vehicle; and
in response to determining that a person is present, sending, from the GNSS tracker to a server, a message comprising data indicative of a person having been detected.
